(19) United States
(12) Patent Application Publication
(10) Pub. No.: US 2018/0060453 A1
(43) Pub. Date: Mar. 1, 2018

(54) UNIVERSAL VERIFICATION METHODOLOGY (UVM) REGISTER ABSTRACTION LAYER (RAL) PAINTER

(71) Applicant: Raytheon Company, Waltham, MA (US)

(72) Inventor: Neel Shah, Marana, AZ (US)

(73) Assignee: Raytheon Company, Waltham, MA (US)

(21) Appl. No.: 15/245,404

(22) Filed: Aug. 24, 2016

(51) Int. Cl. G06F 17/50

(52) U.S. Cl. CPC G06F 17/5009; G06F 17/5081; G06F 17/5045

(57) ABSTRACT

Described embodiments provide systems and methods for verifying functionality of a circuit design under test (DUT). A verification method includes generating a transaction stream for a communication interface of the DUT. The transaction stream includes one or more transactions that are associated with commands of the communication interface and test data associated with the commands. The transaction stream is sent to the DUT via the communication interface. Responses sent from the DUT via the communication interface are monitored. The transactions and the responses are classified based upon one or more characteristics of the transactions and the responses. A graphical representation of the transactions and responses is generated based upon the classification.

### BACKGROUND

Due to the high costs associated with developing an integrated circuit (IC), first-pass success in IC fabrication can be critical to business success and profit margins. Therefore, it can be beneficial for engineers to verify the functionality of an IC design before semiconductor fabrication or manufacturing. For example, many ICs may include complex circuit components, signal routings and logic blocks that should be debugged or verified to function substantially as expected prior to fabrication of the IC. Functional verification of the IC design may include verifying that the design conforms to certain specification parameters as well as certain functional parameters. Functional verification may include generating Register Transfer Level (RTL) representations of various circuit elements of the IC design that represent the functionality of the circuit element for several clock cycles of operation of the IC. Generating and verifying the RTL representations can be a difficult and time consuming task.

Further, many modern ICs may include multiple communication interfaces (e.g., Ethernet, Universal Serial Bus (USB), Peripheral Component Interconnect Express (PCIe), or other interfaces that are not easily decoded from viewing a signal timing waveform. Thus, it can be difficult to verify that correct stimulus signals have been received (e.g., via the communication interfaces) by a design under test (DUT) and that correct responses signals have been sent from the DUT (e.g., via the communication interfaces).

### SUMMARY

This Summary is provided to introduce a selection of concepts in a simplified form that are further described below in the Detailed Description. This Summary is not intended to identify key or essential features or combinations of the claimed subject matter, nor is it intended to be used to limit the scope of the claimed subject matter.

In one aspect, a system for verifying functionality of a circuit design under test (DUT). The system includes a control station having at least one graphical user interface and an emulator in communication with the control station. The emulator includes a verification component and a register abstraction layer (RAL). The verification component implements the DUT and the RAL implements one or more communication interfaces of the DUT. The emulator generates a transaction stream for a communication interface of the DUT, and the transaction stream includes one or more transactions that are associated with commands of the communication interface and test data associated with the commands. The transaction stream is sent to the DUT via the communication interface. One or more associated responses sent from the DUT via the communication interface are monitored. A RAL painter is in communication with the emulator and the control station. The RAL painter classifies the transactions and the responses based upon one or more characteristics of the transactions and the responses and generates a graphical representation of the transactions and responses based upon the classification.

In another aspect, a method for verifying functionality of a circuit design under test (DUT) is provided. The method includes generating a transaction stream for a communication interface of the DUT. The transaction stream includes one or more transactions that are associated with commands of the communication interface and test data associated with the commands. The transaction stream is sent to the DUT via the communication interface. Responses sent from the DUT via the communication interface are monitored. The transactions and the responses are classified based upon one or more characteristics of the transactions and the responses. A graphical representation of the transactions and responses is generated based upon the classification.

In another aspect, a method for displaying decoded data associated with a communications link is provided. The method includes displaying a graphical user interface comprising a protocol description window, a protocol waveform window and a register abstraction layer (RAL) painter window. Based upon commands and data sent on the communications link, one or more waveforms each associated with a signal of the communication interface are generated and displayed in the protocol waveform window. One or more transaction windows are generated, each associated with a command and associated data sent on the communications link. One or more visual attributes of each transaction window are configured based upon one or more characteristics of the associated command and associated data. The associated command and associated data are displayed in the associated transaction window with the configured visual attributes.

### BRIEF DESCRIPTION OF THE DRAWING FIGURES

Other aspects, features, and advantages of the described embodiments will become more fully apparent from the following detailed description, the appended claims, and the accompanying drawings in which like reference numerals identify similar or identical elements. Reference numerals that are introduced in the specification in association with a drawing figure might be repeated in one or more subsequent figures without additional description in the specification in order to provide context for other features.

FIG. 1 is a block diagram of an illustrative system to verify an integrated circuit (IC) design in accordance with described embodiments;

FIG. 2 is a flow diagram showing an illustrative process for verifying an IC design in accordance with described embodiments;

FIG. 3 is a flow diagram showing an illustrative process for initializing the IC verification process of FIG. 2 in accordance with described embodiments;

FIG. 4 is a flow diagram showing an illustrative process for painting a register abstraction layer (RAL) of the verification process of FIG. 2 in accordance with described embodiments;

FIG. 5 is a flow diagram showing additional detail of the illustrative RAL painting process of FIG. 4 in accordance with described embodiments;

FIG. 6 is a flow diagram showing additional detail of the illustrative RAL painting process of FIG. 5 in accordance with described embodiments;

FIG. 7 is a block diagram showing illustrative output of the illustrative RAL painting processes of FIGS. 4-6 in accordance with described embodiments;

FIGS. 8A and 8B are illustrative displays of the output of the RAL painting processes of FIGS. 4-6 on a graphical user interface (GUI) of a test controller of the system of FIG. 1 in accordance with described embodiments; and

FIG. 9 is a block diagram showing a hardware architecture of an illustrative test controller of the system of FIG. 1 in accordance with described embodiments.

### DETAILED DESCRIPTION

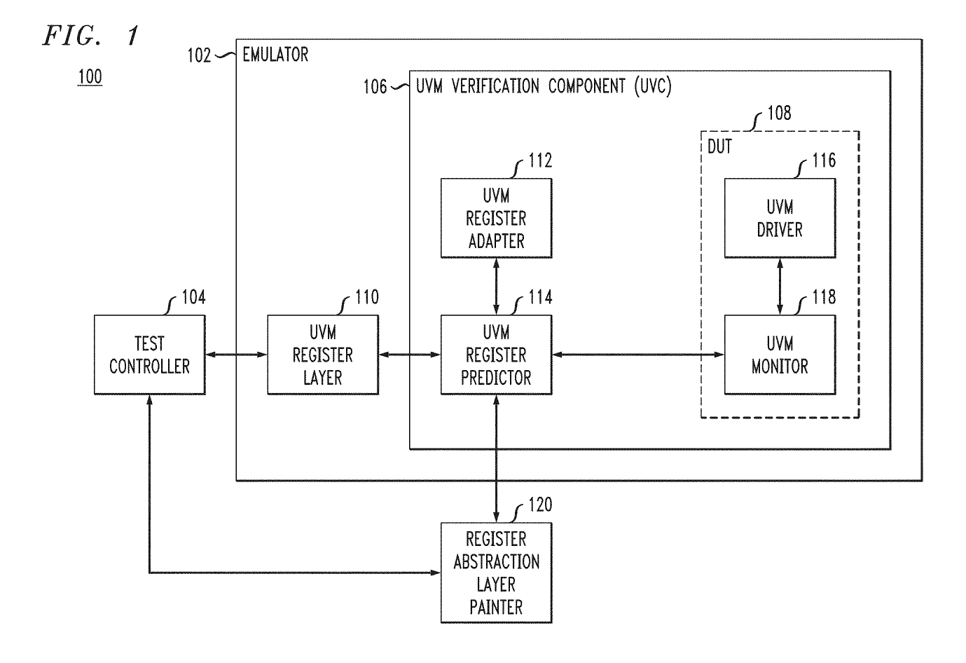

Referring to FIG. 1, a block diagram of illustrative integrated circuit (IC) verification system is shown as “testbench” 100. In some embodiments, testbench 100 may be implemented as a Universal Verification Methodology (UVM) testbench. A UVM testbench may provide automatic test generation, self-checking tests, and coverage metrics to verify an IC design under test (DUT), shown as DUT 108. A DUT may be verified by setting verification goals and testbench parameters to generate test stimuli (e.g., either directed or constrained-random stimuli) that are applied to the DUT via one or more UVM drivers 116. One or more monitors 118 may identify behavior of DUT 108 in response to the test stimuli to verify the DUT. UVM is described in greater detail in the Universal Verification Methodology (UVM 1.1 User's Guide, published May 18, 2011 by Accellera Systems Initiative of Elk Grove, Calif., USA, which is incorporated by reference herein.

As shown in FIG. 1, illustrative testbench 100 may include emulator 102 to implement a design under test as DUT 108 as part of a UVM verification component (UVC) 106. For example, emulator 102 may use a hardware verification language (HDL) to implement DUT 108 for an application specific integrated circuit (ASIC), field programmable gate array (FPGA), or system on chip (SoC).

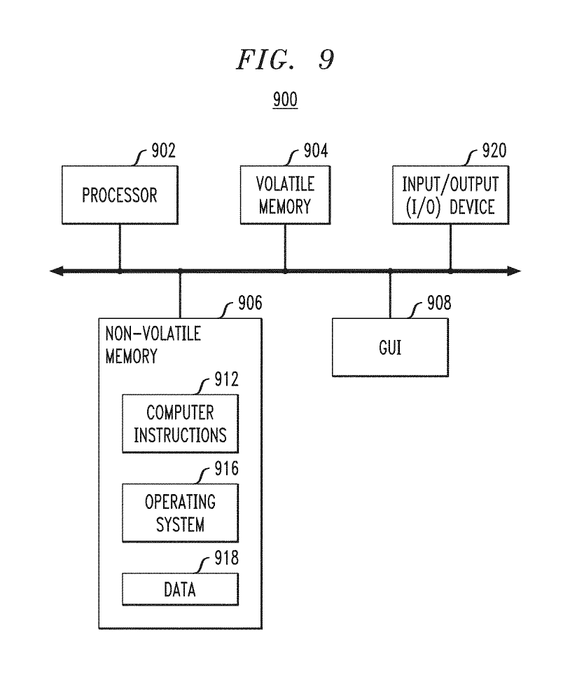

Data may be applied to the DUT from UVM register layer 110. For example, UVM register layer 110 may include networking packets, bus transactions, and instructions to be employed to verify DUT 108. The packets, transactions and instructions stored in UVM register layer 110 may generally be stored in a protocol-agnostic format (e.g., a general format that can be converted for use with specific protocols). In a typical test, many data items are generated and sent to the DUT, for example to test certain conditions or in a random order. Test controller 104 may allow a user to change configuration properties of the UVM register layer 110 and UVC 106 to make changes to tests, test data and DUT 108 during testing and verification of the design. In some embodiments, test controller 104 may be a computing device such as described in regard to FIG. 9.

UVM register adapter 112 converts the protocol-agnostic packets, transactions and instructions stored in UVM register layer 110 into protocol-specific packets, transactions and instructions associated with a specific UVM driver 116. For example, the Ethernet protocol may define valid values and attributes for an Ethernet data packet based upon the protocol-agnostic data stored in UVM register layer 110.

UVM register layer 110 may include a sequencer (not shown) that orders instructions to be provided to UVM driver 116. Ordering the instructions may provide a random or structured sequence of stimulus data to verify DUT 108. The sequencer may also generate response data based upon response signals from DUT 108 sampled by UVM monitor 118.

DUT 108 may include one or more UVM drivers 116. A UVM driver may be employed to emulate specific portions of logic that operate the DUT. For example, a UVM driver may be associated with a specific communications interface bus, for example Ethernet, Universal Serial Bus (USB), Peripheral Component Interconnect Express (PCIe), or other interfaces. A given UVM driver 116 may repeatedly receive data from UVM register adapter 112 and drive stimulus signals to DUT 108. For example, UVM driver 116 may control read/write signals, address buses, and data buses for a number of clock cycles to perform data transfers for the associated communications interface bus. UVM monitor 118 may sample the stimulus signals applied to DUT 108 and sample the response signals from DUT 108. UVM monitor 118 may collect coverage information and perform checking. For example, UVM monitor 118 may extract signal information from a bus and plot output waveforms.

UVM predictor 114 may convert the protocol-specific packets, transactions and instructions associated with a specific UVM driver 116 that are sampled by UVM monitor 118 into protocol-agnostic packets, transactions and instructions stored in UVM register layer 110.

Some designs may include one or more complex communication interface buses, for example Ethernet, Universal Serial Bus (USB), Peripheral Component Interconnect Express (PCIe), or other interfaces. Such complex bus protocols may generally be difficult to decode from signal waveform timing diagrams. Thus, in conventional systems, verifying that the correct response has occurred for an applied stimulus can be difficult and time consuming (e.g., to decode signal timing diagrams to verify the DUT).

Register Abstraction Layer (RAL) painter 120 provides fully decoded bus accesses (e.g., read and/or write signals and data) for any protocol employed by DUT 108. The decoded bus accesses may then be published in a formatted (e.g., painted) display of a graphical user interface (GUI) of test controller 104. The painted decoded bus accesses may then be employed by a user of testbench 100 to verify and/or debug the design of DUT 108. In described embodiments, RAL painter 120 is protocol-agnostic and does not rely on any specific bus protocol for the information it publishes.

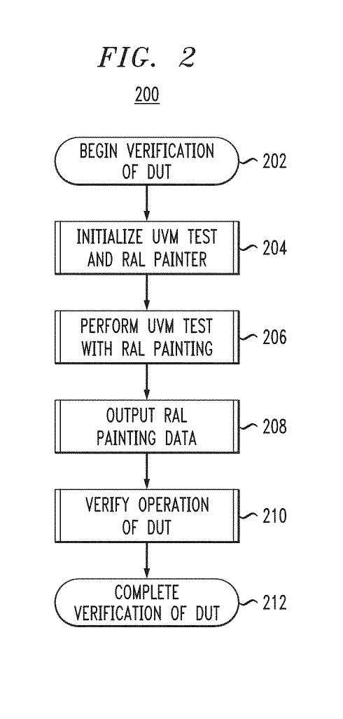

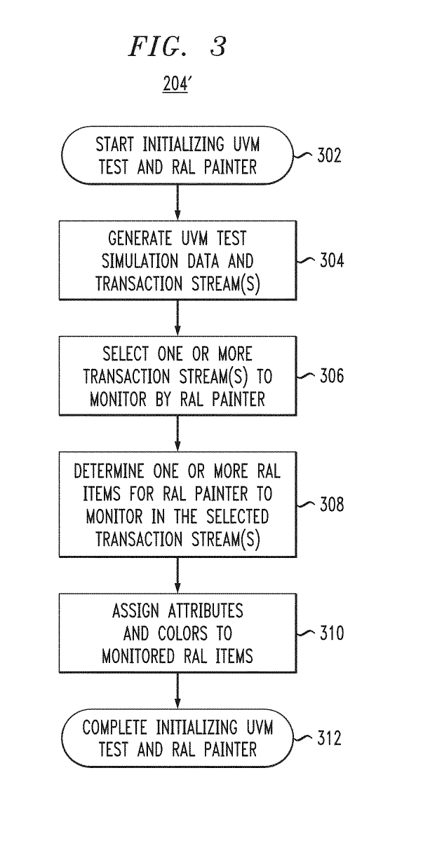

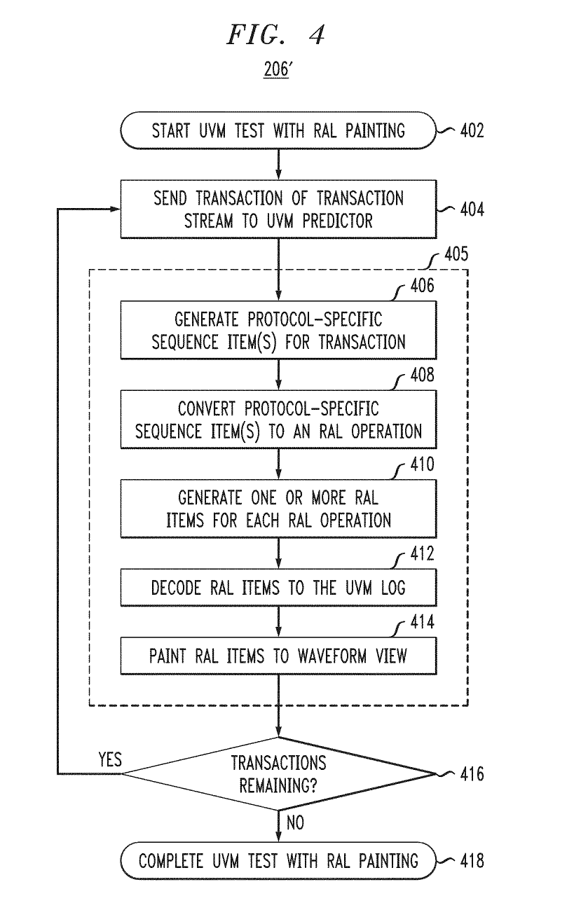

FIG. 2 shows a flow diagram of an illustrative process to verify a DUT, shown as verification process 200. At block 202, process 200 begins. At block 204, the UVM testbench (e.g., testbench 100 of FIG. 1) and the RAL painter (e.g., RAL painter 120 of FIG. 1) are initialized. Block 204 is described in greater detail in regard to FIG. 3. At block 206, testbench 100 performs the UVM test with RAL painting. Block 206 is described in greater detail in regard to FIG. 4. At block 208, RAL painter 120 outputs the RAL painted data (e.g., to test controller 104 of FIG. 1). At block 210, the design of DUT 108 is verified and/or debugged, for example based upon the output RAL painted data. At block 212, verification process 200 completes.

FIG. 3 shows additional detail of UVM initialization block 204 of FIG. 2, shown as process 204′. At block 302, process 204′ begins. At block 304, UVM test simulation data may be generated and stored, for example, as protocol-agnostic UVM test data in UVM register layer 110 of FIG. 1. Further, one or more transaction streams may be generated that provide either a random or structured sequence of stimulus data to verify DUT 108. The UVM test simulation data and transaction streams may be generated based upon one or more test conditions, sample data, and configuration options provided by test controller 104 (e.g., provided by a user of testbench 100).

At block 306, one or more transaction streams may be provided to DUT 108 and monitored by UVM monitor 118. The one or more transaction streams may also be monitored by RAL painter 120. At block 308, RAL painter 120 may determine one or more items (such as reads, writes, accesses, etc.) to monitor and display as painted decoded bus accesses.

At block 310, the one or more items determined at block 308 may each be assigned a visual attribute, such as a paint color, font typeface, font size, display location, or other attributes for display in the GUI of test controller 104 and/or for display in a graphical simulation log. For example, in an embodiment, RAL painter 120 may provide a colorized (or otherwise visually formatted) transaction stream to aid a user of testbench 100 in verifying and/or debugging the design of DUT 108. For example, RAL painter 120 may present data in a waveform viewing window of the GUI of test controller 104 to show, for a given register, the register name, register address, type of access (e.g., read or write), a timestamp for when the access occurred, and a breakdown of the values of one or more individual fields of the register. Some embodiments may also show waveforms of the associated bus signals. RAL painter 120 may also generate a simulation log (e.g., a plain text or regular expression (RegEx) formatted log of the data displayed graphically in the waveform viewer). In some embodiments, the simulation log may also include the graphical transaction stream data. In other embodiments, test controller 104 may generate graphical transaction stream data based upon a plain text of RegEx simulation log. At block 312, process 204′ completes.

FIG. 4 shows additional detail for UVM test and RAL painting block 206 of FIG. 2, shown as process 206′. At block 402, process 206′ begins. At block 404, a transaction stream may be sent to UVM register predictor 114 from UVM register layer 110. As described herein, the transaction stream may be a protocol-agnostic stream of UVM data, transactions, and/or instructions. At block 406, UVM register predictor 114 may send the transaction stream (or a portion of the transaction stream) to UVM register adapter 112, which generates a protocol-specific transaction stream (e.g., one or more protocol-specific sequence items) corresponding to the protocol-agnostic transaction stream. At block 408, UVM register adapter 112 and UVM register predictor 114 convert the protocol-specific sequence item into a protocol-agnostic register abstraction layer (RAL) operation. At block 410, one or more RAL items may be generated corresponding to the RAL operation. At block 412, RAL painter 120 decodes the RAL items and provides decoded data to a simulation log. At block 414, RAL painter 120 generates the graphical output (e.g., paints) to display on the GUI of test controller 104.

For example, in an embodiment, UVM register predictor 114 may use the bus2reg and reg2bus UVM functions to implement blocks 406 and 408, for example, of FIG. 4. These functions convert from the protocol-agnostic UVM register layer items into one or more protocol-specific sequence_item (and vice-versa). For example, UVM register adapter 112 may employ the bus2reg function to convert a protocol-specific transaction stream sampled by UVM monitor 118 into a protocol-agnostic UVM transaction stream item for processing by RAL painter 120. For example, UVM monitor 118 may generate a protocol-specific sequence_item based upon sampling the bus communications. The protocol-specific sequence_item may be provided to UVM register predictor 114 (uvm_reg_predictor).

UVM register predictor 114 may employ the bus2reg function of UVM register adapter 112 to convert the protocol-specific sequence_item to a uvm_reg_bus_op data object. UVM register predictor 114 may then generate a protocol-agnostic uvm_reg_item from the uvm_reg_bus_op data object that corresponds to the protocol-specific decoded bus access. RAL painter 120 may then decode the uvm_reg_item and generate a corresponding graphical representation of the protocol-specific decoded bus access (for example by using a transaction stream application program interface (API) to paint the bus access in a waveform view of test controller 104) and also provide the bus access to a simulation log of test controller 104.

For example, in some embodiments, the API for painting the bus access may be based upon a simulator program operating on test controller 104. Several simulator programs are available, for example, Questa® by Mentor Graphics, Inc. of Wilsonville, Oreg., VCS® by Synopsys, Inc. of Mountain View, Calif., and the Incisive platform by Cadence Design Systems, Inc. of San Jose, Calif. For example, an embodiment of RAL painter 120 may employ API calls for Mentor's Questa®, such as $create_transaction_stream, $begin_transaction, $add_color, $add_attribute, $end_transaction, and/or $free_transaction to paint transactions to the simulator (e.g., to paint the transactions to a GUI of test controller 104).

At block 416, if there are additional transactions to paint, process 206′ returns to block 404. As indicated by dashed line 405, blocks 406-414 may be repeated, in series or in parallel, for one or more transactions of one or more transaction streams to verify DUT 108. If, at block 416 there are no transactions remaining to paint, process 206′ completes at block 418.

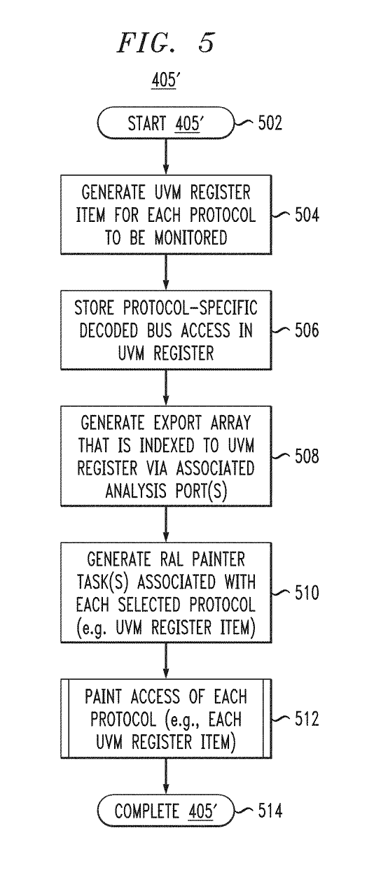

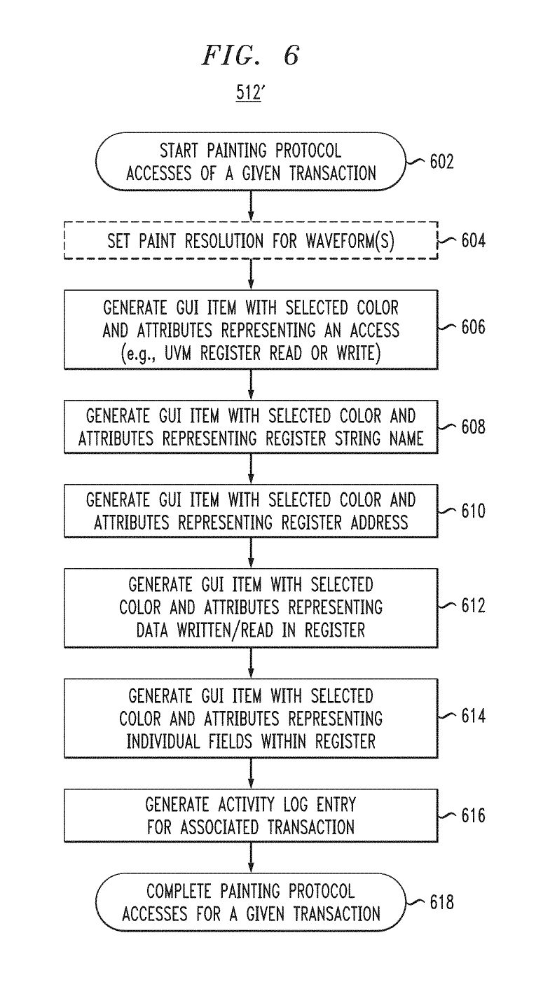

FIG. 5 shows additional detail of the process indicated by dashed line 405 of FIG. 4, shown as process 405′. At block 502, process 405′ begins. At block 504, a UVM register item may be generated for each protocol (or bus) to be monitored. At block 506, decoded protocol-specific bus access data may be stored in the generated UVM register. At block 508, an export array may be generated that is indexed to an associated UVM register via one or more analysis ports. At block 510, one or more RAL painter tasks may be generated that are associated with each protocol (or bus) to be monitored (e.g., associated with each UVM register item generated at block 504). At block 512, RAL painter 120 may generate (e.g., paint) a graphical display of the activity of the monitored buses (e.g., each UVM register item). Block 512 is described in greater detail in regard to FIG. 6. At block 514, process 405′ completes.

For example, in an embodiment such as shown in FIG. 5, RAL painter 120 may generate an associative array (uvm_export) indexed to registers (uvm_reg_maps) of UVM register layer 110. The uvm_export array may store data generated by UVM register predictor 114 and/or data observed by UVM monitor 118 (for example, uvm_reg_predictor analysis_port (reg_ap)). In some embodiments, RAL painter 120 may initiate a UVM monitor (e.g., 118) for each register (e.g., each uvm_reg_map) to monitor bus accesses for each communications bus (e.g., each uvm_reg_item).

For each bus access, at block 512, RAL painter 120 may paint a graphical display of a transaction stream by decomposing each UVM register item (e.g., each uvm_reg_item) into one or more graphical elements representing: (1) an access type (e.g., uvm_read or uvm_write) associated with the UVM register item, (2) a register name associated with the UVM register item, (3) a register address associated with the UVM register item, (4) a value written to or read from the full register (e.g., bitwidth data of the register), (5) one or more values of individual fields within the register. Some embodiments may also include a timestamp indicating a time the transaction was observed. Similar data may also be included in a simulation log provided to test controller 104. RAL painter 120 may then format one or more visual attributes of the graphical elements based upon the decomposed items.

Referring to FIG. 6, additional detail of block 512 is shown as process 512′. At block 602, process 512′ begins. At block 604, some embodiments of RAL painter 120 may optionally determine a resolution to display as a painted output. For example, a test may be performed over a determined time duration, and RAL painter 120 may paint bus accesses over a selected portion of the time duration. The resolution of the painted output may be an aesthetic option provided to an end user of testbench 100 to overlay the graphical elements with the timing diagram of the respective interface.

At block 606, one or more graphical elements (e.g., elements displayed on a GUI of test controller 104) are generated having selected visual attributes based upon one or more characteristics of the bus access. For example, RAL painter 120 may colorize data related to a given bus access based on the access type (e.g., write or read). Although described herein as using colors to differentiate bus accesses, other visual attributes may be used, either alternatively or additionally, for example visual attributes such as a font typeface, a font size, a font color, or attributes such as boldface, italics or underlining, or other visual attributes.

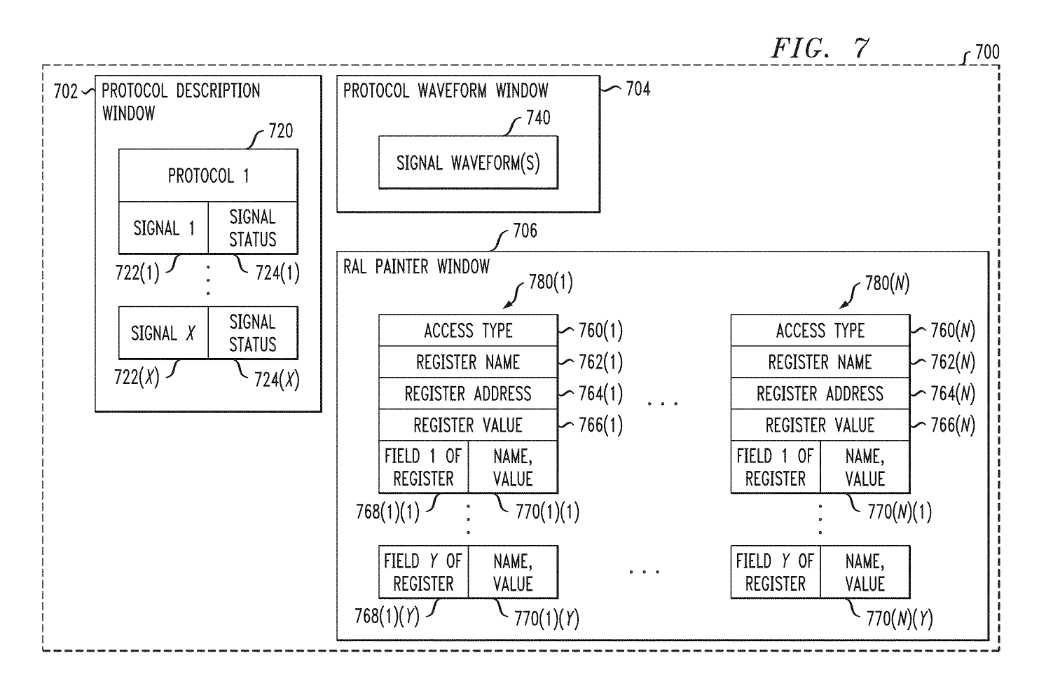

Referring to FIG. 7, an illustrative graphical user interface 700 of test controller 104 (or of a simulator program operating on test controller 104) is shown. GUI 700 may include a plurality of window segments to display information about a communication bus simulation. For example, as shown in FIG. 7, GUI 700 may include protocol description window 702, protocol waveform window 704, and RAL painter window 706.

Protocol description window 702 may be employed to display information about a selected communications bus and individual signals of the bus. For example, as shown in FIG. 7, protocol description window 702 may include a protocol label 720 to indicate the selected protocol (e.g., Ethernet, SPI, USB, etc.). Protocol description window 702 may include one or more signal labels 722(1)-722(X) and one or more signal status indicators 724(1)-724(X) for each of one or more corresponding signals of the selected protocol. For example, a serial peripheral interface (SPI) bus has 4 signals: select (CSBN), serial clock (CLK), master-in, slave-out (MISO) and master-out, slave-in (MOSI).

Protocol waveform window 704 may be employed to display one or more signal waveforms 740 associated with the simulation. For example, protocol waveform window 704 may display waveforms for the CSBN, CLK, MISO and MOSI signals of a simulated SPI bus.

RAL painter window 706 may be employed to display one or more painted transactions of the simulated bus. For example, RAL painter window 706 may include one or more transaction windows 780(1)-780(N), collectively referred to as transaction windows 780. Each transaction window 780 may include information about a specific transaction of the selected bus. For example, each transaction window 780 may include access type indicator 760, register name indicator 762, register address indicator 764, register value indicator 766, one or more register field name indicators 768, and one or more register field value indicators 770. Each transaction window 780 (and/or one or more of indicators 760-770) may have one or more visual attributes formatted by RAL painter 120 based upon characteristics of the transaction corresponding to the given transaction window. For example, as described herein, RAL painter 120 may select a background color of the transaction window based upon the access type (e.g., read or write) of the corresponding transaction.

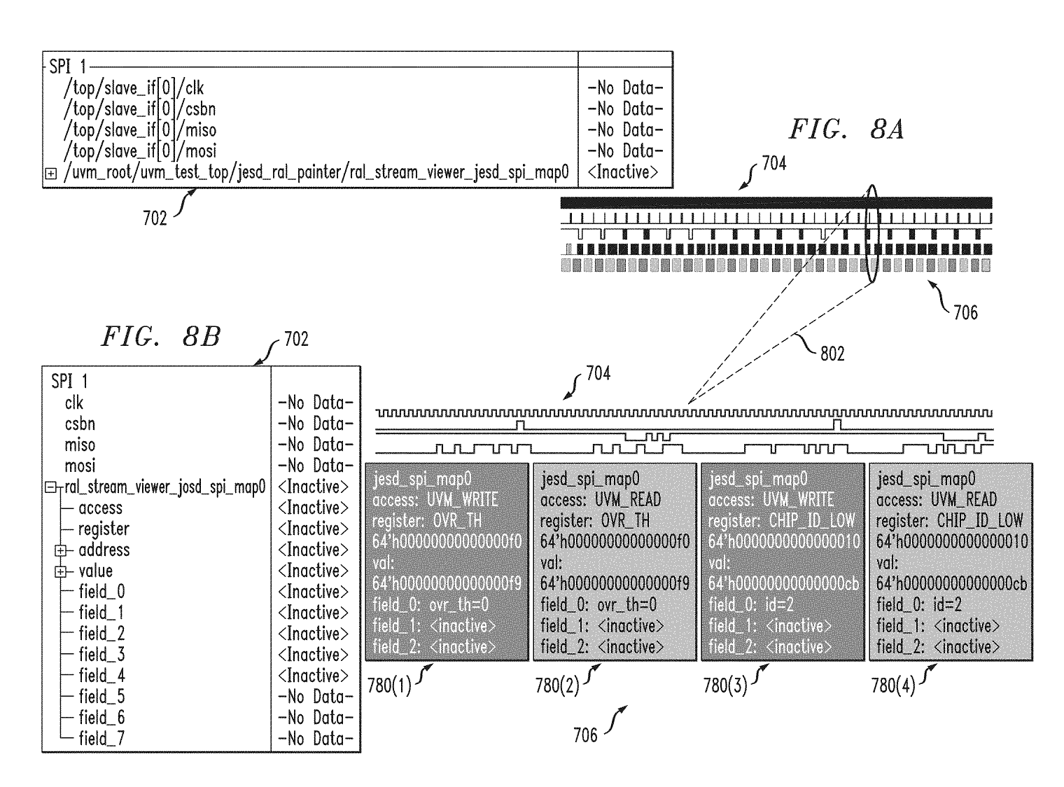

Referring to FIGS. 8A and 8B, an illustrative GUI display is shown. As shown in FIG. 8A, protocol description window 702 may show data related to a selected SPI bus and status information for its corresponding signals (CSBN, CLK, MISO and MOSI). Protocol waveform window 704 may show waveforms related to each of the signals (CSBN, CLK, MISO and MOSI), and RAL painter window 706 may show graphical indicators of individual transactions transmitted by the signals (CSBN, CLK, MISO and MOSI).

FIG. 8B shows a zoomed-in view of a selected portion of protocol waveform window 704 and RAL painter window 706, as indicated by line 802. As shown in FIG. 8B, protocol description window 702 may show data related to a selected SPI bus and status information for its corresponding signals (CSBN, CLK, MISO and MOSI), as well as data for related UVM registers and specific fields within the registers. Protocol waveform window 704 may show waveforms related to each of the signals (CSBN, CLK, MISO and MOSI), and RAL painter window 706 may show transaction windows 780(1)-780(4) as graphical indicators of individual transactions transmitted by the signals (CSBN, CLK, MISO and MOSI). For example, as shown in FIG. 8B, each transaction window 780 may include access type indicator 760, register name indicator 762, register address indicator 764, register value indicator 766, one or more register field name indicators 768, and one or more register field value indicators 770.

As shown in FIGS. 8A and 8B, RAL painter 120 may select a background color of the transaction window based upon the access type (e.g., read or write) of the corresponding transaction. For example, FIG. 8B shows write operations having a dark background color and read operations having a light background color. Although shown in FIG. 8B as employing a grayscale color palette, described embodiments may employ any color palette available to test controller 104 (e.g., grayscale, color gradient, RGB, or other color palettes available by an operating system of test controller 104).

Referring back to FIG. 6, at block 606, RAL painter 120 generates a GUI item (e.g., a transaction window 780) having selected visual attributes (e.g., color, etc.) associated with a given bus access or transaction. At block 606, a GUI item (e.g., access type indicator 760) may also be generated. At block 608, a GUI item (e.g., register name indicator 762) is generated. At block 610, a GUI item (e.g., register address indicator 764) is generated. At block 612, a GUI item (e.g., register value indicator 766) is generated. At block 614, one or more GUI items (e.g., register field name indicators 768 and register field value indicators 770) are generated. The GUI items generated at blocks 608-614 may also have selected visual attributes (e.g., color, etc.). At block 616, the transaction data may also be written into a simulation activity log of test controller 104. At block 618, process 512′ completes.

As described herein, RAL painter 120 may automatically process register accesses, and, thus, may be employed as a UVM class in a testbench (e.g., testbench 100) to replace or augment the conventional UVM scoreboard class.

Thus, described embodiments may provide automatic (e.g., uvm_export) creation based upon the registers of UVM register layer 110 (e.g., the uvm_reg_map). RAL painter 120 provides threaded, independent processing of UVM traffic on one or more communications buses, and provides automatic content classification and display in any simulator's wave and/or log viewers and can be employed to augment and/or replace UVM scoreboards of conventional verification testbenches. By graphically classifying the traffic on the communications buses, RAL painter 120 may greatly reduce time spent decoding signal/timing information for each communications bus to verify the correct stimulus and response have occurred (e.g., to verify DUT 108). For example, manual translation of timing waveforms into meaningful data and/or manual translation of numerically encoded addresses and/or data fields can be reduced or, ideally, eliminated to verify and/or debug DUT 108.

Described embodiments of RAL painter 120 provide automatic protocol-agnostic interface/bus protocol decoding and debugging information to an end user of testbench 100. As described herein, RAL painter 120 may provide class extension templates for chip-level prediction, functional coverage, and scoreboard generation for UVM design testing and verification (e.g., of DUT 108). Embodiments of RAL painter 120 provide full visibility of all UVM registers (e.g., UVM register layer 110) for transaction-based stimuli produced on external physical interfaces to DUT 108.

Some embodiments of RAL painter 120 may employ an interface router scoreboard to automatically predict inbound traffic to DUT 108 that is forwarded by DUT 108 without modification and may highlight (e.g., by painting) unexpected (e.g., out of bounds or 00B) outbound traffic sent by DUT 108.

Further, some embodiments of RAL painter 120 may “replay” simulated test conditions onto physical communications buses to test actual hardware systems (e.g., once DUT 108 is generated as an actual IC or SOC). Since RAL painter 120 provides register/memory based stimulus applied to DUT 108 and translates the protocol-agnostic uvm_reg_item (rather than painting it), the protocol-agnostic uvm_reg_item may also be provided to a script (e.g., a Python script, etc.), and the script may be employed to replay a simulated UVM test case directly onto actual hardware to compare between simulation data and actual hardware test data.

As described herein, embodiments of RAL painter 120 aggregate various custom, application specific, and/or complex communications bus protocols into a common UVM bus protocol via the uvm_reg_item to view transactions/activity/stimulus sent to and from DUT 108. Thus, RAL painter 120 may provide transaction level modeling (TLM) for each communications interface of DUT 108.

Referring to FIG. 9, in some embodiments, test controller 104 of FIG. 1 may be implemented as one or more computers or coupled to one or more computers. For example, computer 900 may include processor 902, volatile memory 904 (e.g., RAM), non-volatile memory 906 (e.g., a hard disk drive, a solid state drive such as a flash drive, a hybrid magnetic and solid state drive, etc.), graphical user interface (GUI) 908 (e.g., a display or touchscreen, etc.) and input/output (I/O) device 920 (e.g., a mouse, a keyboard, a touchscreen, and so forth). Non-volatile memory 906 stores computer instructions 912, an operating system 916 and data 918 such that, for example, the computer instructions 912 are executed by the processor 902 out of volatile memory 904 to perform at least a portion of processes 200, 204′, 206′, 405′, 604′, and 512′ (e.g., FIGS. 2, 3, 4, 5, and 6). Program code may be applied to data entered using an input device of GUI 908 or received from I/O device 920.

The processes described herein are not limited to use with the hardware and software of FIG. 9 and may find applicability in any computing or processing environment and with any type of machine or set of machines that is capable of running a computer program. The processes described herein may be implemented in hardware, software, or a combination of the two.

The processes described herein are not limited to the specific embodiments described. For example, processes 200, 204′, 206′, 405′, 604′, and 512′ are not limited to the specific processing order shown in FIGS. 2, 3, 4, 5, and 6. Rather, any of the blocks may be re-ordered, combined or removed, or performed in parallel or in serial, as necessary, to achieve the results set forth herein.

Processor 902 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in processing devices including, for example, a general purpose microprocessor, a digital signal processor (DSP), a reduced instruction set computer (RISC), a complex instruction set computer (CISC), an application specific integrated circuit (ASIC), a field programmable gate array (FPGA), a system on chip (SOC), a programmable logic array (PLA), a microcontroller, an embedded controller, a multi-core processor, and/or others, including combinations of the above. In some embodiments, the “processor” may be embodied in a microprocessor with associated program memory. In some embodiments, the “processor” may be embodied in a discrete electronic circuit. The “processor” may be analog, digital or mixed-signal. In some embodiments, the “processor” may be one or more physical processors or one or more “virtual” (e.g., remotely located or “cloud”) processors.

When implemented on a processing device, the program code segments combine with the processor to provide a unique device that operates analogously to specific logic circuits. Described embodiments may be implemented as an electronic circuit, an integrated circuit, a multi-chip module, a single card, or a multi-card circuit pack. Further, as would be apparent to one skilled in the art, various functions of circuit elements may also be implemented as processing blocks in a software program. Such software may be employed in, for example, a digital signal processor, microcontroller, or general purpose computer. Thus, described embodiments may be implemented in hardware, a combination of hardware and software, software, or software in execution by one or more processors.

Some embodiments may be implemented in the form of methods and apparatuses for practicing those methods. Described embodiments may also be implemented in the form of program code, for example, stored in a storage medium, loaded into and/or executed by a machine, or transmitted over some transmission medium or carrier, such as over electrical wiring or cabling, through fiber optics, or via electromagnetic radiation. Described embodiments may also be implemented in the form of a bitstream or other sequence of signal values electrically or optically transmitted through a medium, and/or stored magnetic-field variations in a magnetic recording medium that may be generated using a method and/or an apparatus as described herein. A non-transitory machine-readable medium may include one or more tangible storage media and/or one or more “virtual” (e.g., remotely located or “cloud”) storage media. A non-transitory machine-readable medium may include storage devices such as magnetic recording media including hard drives, floppy diskettes, and magnetic tape media, optical recording media including compact discs (CDs) and digital versatile discs (DVDs), solid state memory such as flash memory, hybrid magnetic and solid state memory, non-volatile memory, volatile memory, and so forth, but does not include a transitory signal per se. When embodied in a non-transitory machine-readable medium, and the program code is loaded into and executed by a machine, such as a computer, the machine becomes an apparatus for practicing the method.

### Additional Embodiments

Some embodiments provide a system for verifying functionality of a circuit design under test (DUT), the system comprising: a control station comprising at least one graphical user interface (GUI); an emulator in communication with the control station, the emulator comprising a verification component and a register abstraction layer (RAL), wherein the verification component is configured to implement the DUT and wherein the RAL is configured to implement one or more communication interfaces of the DUT, wherein the emulator is configured to: generate a transaction stream for a communication interface of the DUT, the transaction stream comprising one or more transactions, the transactions associated with commands of the communication interface and test data associated with the commands; send the transaction stream to the DUT via the communication interface; and monitor one or more associated responses sent from the DUT via the communication interface; and a RAL painter in communication with the emulator and the control station, the RAL painter configured to: classify the transactions and the responses based upon one or more characteristics of the transactions and the responses; generate a graphical representation of the transactions and responses based upon the classification; and display the graphical representation on the control station GUI.

In some embodiments, the emulator is further configured to: generate one or more protocol-specific sequence items for each transaction, protocol-specific sequence items specific to a protocol of the communication interface; and convert the one or more protocol-specific sequence items into one or more associated protocol-agnostic register abstraction layer (RAL) items.

In some embodiments, the emulator is further configured to: generate, based upon the transaction stream, one or more protocol-specific response sequence items; and convert the one or more protocol-specific response sequence items into one or more associated protocol-agnostic register abstraction layer (RAL) items.

In some embodiments, the RAL painter is configured to decode the protocol-agnostic RAL items into source commands and test data.

In some embodiments, the RAL painter is configured to generate an activity log and provide each of the decoded source commands and test data to the activity log.

In some embodiments, the RAL painter is configured to: generate one or more scripts based upon the decoded source commands and test data; and apply the scripts to an integrated circuit implementing the DUT.

In some embodiments, the control station is configured to display a graphical user interface comprising a protocol description window, a protocol waveform window and a RAL painter window; and the RAL painter is configured to: generate, based upon the protocol-agnostic RAL items, one or more waveforms each associated with a signal of the communication interface, and display the one or more waveforms in the protocol waveform window; generate, based upon the protocol-agnostic RAL items, one or more transaction windows, each transaction window associated with a decoded source command and test data; configure one or more visual attributes of each transaction window based upon one or more characteristics of the associated decoded source command and test data; and display the associated decoded source command and test data in the associated transaction window with the configured visual attributes.

In some embodiments, the RAL painter is configured to set a color of each transaction window based upon a type of the associated decoded source command.

In some embodiments, the type of the associated decoded source command comprises one of a read operation and a write operation.

Some embodiments provide a computer-implemented method for verifying functionality of a circuit design under test (DUT), the method comprising: generating, by an emulator coupled to a control station, a transaction stream for a communication interface of the DUT, the transaction stream comprising one or more transactions, the transactions associated with commands of the communication interface and test data associated with the commands; sending, by the emulator, the transaction stream to the DUT via the communication interface and monitoring, by the emulator, one or more associated responses sent from the DUT via the communication interface; classifying, by a register abstraction layer painter of the emulator, the transactions and the responses based upon one or more characteristics of the transactions and the responses; generating, by the register abstraction layer painter of the emulator, a graphical representation of the transactions and responses based upon the classification; and displaying, by the control station, the graphical representation on a graphical user interface (GUI).

In some embodiments, generating the transaction stream further comprises: generating one or more protocol-specific sequence items for each transaction, protocol-specific sequence items specific to a protocol of the communication interface; and converting the one or more protocol-specific sequence items into one or more associated protocol-agnostic register abstraction layer (RAL) items.

In some embodiments, monitoring the one or more associated responses further comprises: generating, based upon the transaction stream, one or more protocol-specific response sequence items; and converting the one or more protocol-specific response sequence items into one or more associated protocol-agnostic register abstraction layer (RAL) items.

In some embodiments, classifying the transactions further comprises decoding the protocol-agnostic RAL items into source commands and test data.

In some embodiments, the method further comprises generating an activity log and providing each of the decoded source commands and test data to the activity log.

In some embodiments, generating a graphical representation of the transactions and responses based upon the classification further comprises: displaying a graphical user interface comprising a protocol description window, a protocol waveform window and a RAL painter window; generating, based upon the protocol-agnostic RAL items, one or more waveforms each associated with a signal of the communication interface, and displaying the one or more waveforms in the protocol waveform window; generating, based upon the protocol-agnostic RAL items, one or more transaction windows, each transaction window associated with a decoded source command and test data; configuring one or more visual attributes of each transaction window based upon one or more characteristics of the associated decoded source command and test data; and displaying the associated decoded source command and test data in the associated transaction window with the configured visual attributes.

In some embodiments, configuring the one or more visual attributes comprises setting a color of each transaction window based upon a type of the associated decoded source command.

In some embodiments, the type of the associated decoded source command comprises one of a read operation and a write operation.

In some embodiments, the method further comprises generating one or more scripts based upon the decoded source commands and test data; and applying the scripts to an integrated circuit implementing the DUT.

Some embodiments provide a method for displaying decoded data associated with a communications link in a graphical user interface (GUI), the method comprising: displaying a graphical user interface comprising a protocol description window, a protocol waveform window and a register abstraction layer (RAL) painter window; generating, based upon commands and data sent on the communications link, one or more waveforms each associated with a signal of the communication interface, and displaying the one or more waveforms in the protocol waveform window; generating one or more transaction windows, each transaction window associated with a command and associated data sent on the communications link; configuring one or more visual attributes of each transaction window based upon one or more characteristics of the associated command and associated data sent on the communications link; and displaying the associated command and associated data in the associated transaction window with the configured visual attributes.

In some embodiments, the method further comprises setting a color of each transaction window based upon a type of the associated decoded source command, wherein the type of the associated decoded source command comprises one of a read operation and a write operation.

Various elements, which are described in the context of a single embodiment, may also be provided separately or in any suitable subcombination. It will be further understood that various changes in the details, materials, and arrangements of the parts that have been described and illustrated herein may be made by those skilled in the art without departing from the scope of the following claims.

We claim:

1. A system for verifying functionality of a circuit design under test (DUT), the system comprising:
a control station comprising at least one graphical user interface (GUI);
an emulator in communication with the control station, the emulator comprising a verification component and a register abstraction layer (RAL), wherein the verification component is configured to implement the DUT and wherein the RAL is configured to implement one or more communication interfaces of the DUT, wherein the emulator is configured to:
generate a transaction stream for a communication interface of the DUT, the transaction stream comprising one or more transactions, the transactions associated with commands of the communication interface and test data associated with the commands;
send the transaction stream to the DUT via the communication interface; and
monitor one or more associated responses sent from the DUT via the communication interface; and
a RAL painter in communication with the emulator and the control station, the RAL painter configured to:
classify the transactions and the responses based upon one or more characteristics of the transactions and the responses;
generate a graphical representation of the transactions and responses based upon the classification; and
display the graphical representation on the control station GUI.

2. The system of claim 1, wherein the emulator is further configured to:
generate one or more protocol-specific sequence items for each transaction, protocol-specific sequence items specific to a protocol of the communication interface; and
convert the one or more protocol-specific sequence items into one or more associated protocol-agnostic register abstraction layer (RAL) items.

3. The system of claim 2, wherein the emulator is further configured to:
generate, based upon the transaction stream, one or more protocol-specific response sequence items; and
convert the one or more protocol-specific response sequence items into one or more associated protocol-agnostic register abstraction layer (RAL) items.

4. The system of claim 3, wherein the RAL painter is configured to decode the protocol-agnostic RAL items into source commands and test data.

5. The system of claim 4, wherein the RAL painter is configured to generate an activity log and provide each of the decoded source commands and test data to the activity log.

6. The system of claim 5, wherein the RAL painter is configured to:
generate one or more scripts based upon the decoded source commands and test data; and
apply the scripts to an integrated circuit implementing the DUT.

7. The system of claim 4, wherein:
the control station is configured to display a graphical user interface comprising a protocol description window, a protocol waveform window and a RAL painter window; and
the RAL painter is configured to:
generate, based upon the protocol-agnostic RAL items, one or more waveforms each associated with a signal of the communication interface, and display the one or more waveforms in the protocol waveform window;
generate, based upon the protocol-agnostic RAL items, one or more transaction windows, each transaction window associated with a decoded source command and test data;
configure one or more visual attributes of each transaction window based upon one or more characteristics of the associated decoded source command and test data; and
display the associated decoded source command and test data in the associated transaction window with the configured visual attributes.

8. The system of claim 7, wherein the RAL painter is configured to set a color of each transaction window based upon a type of the associated decoded source command.

9. The system of claim 8, wherein the type of the associated decoded source command comprises one of a read operation and a write operation.

10. A computer-implemented method for verifying functionality of a circuit design under test (DUT), the method comprising:
generating a transaction stream for a communication interface of the DUT, the transaction stream comprising one or more transactions, the transactions associated with commands of the communication interface and test data associated with the commands;
sending the transaction stream to the DUT via the communication interface and monitoring one or more associated responses sent from the DUT via the communication interface;
classifying the transactions and the responses based upon one or more characteristics of the transactions and the responses;
generating a graphical representation of the transactions and responses based upon the classification; and
displaying the graphical representation on a graphical user interface (GUI).

11. The method of claim 10, wherein generating the transaction stream further comprises:
generating one or more protocol-specific sequence items for each transaction, protocol-specific sequence items specific to a protocol of the communication interface; and
converting the one or more protocol-specific sequence items into one or more associated protocol-agnostic register abstraction layer (RAL) items.

12. The method of claim 11, wherein monitoring the one or more associated responses further comprises:
generating, based upon the transaction stream, one or more protocol-specific response sequence items; and
converting the one or more protocol-specific response sequence items into one or more associated protocol-agnostic register abstraction layer (RAL) items.

13. The method of claim 12, wherein classifying the transactions further comprises decoding the protocol-agnostic RAL items into source commands and test data.

14. The method of claim 13, further comprising generating an activity log and providing each of the decoded source commands and test data to the activity log.

15. The method of claim 13, wherein generating a graphical representation of the transactions and responses based upon the classification further comprises:
displaying a graphical user interface comprising a protocol description window, a protocol waveform window and a RAL painter window;
generating, based upon the protocol-agnostic RAL items, one or more waveforms each associated with a signal of the communication interface, and displaying the one or more waveforms in the protocol waveform window;
generating, based upon the protocol-agnostic RAL items, one or more transaction windows, each transaction window associated with a decoded source command and test data;
configuring one or more visual attributes of each transaction window based upon one or more characteristics of the associated decoded source command and test data; and
displaying the associated decoded source command and test data in the associated transaction window with the configured visual attributes.

16. The method of claim 15, wherein configuring the one or more visual attributes comprises setting a color of each transaction window based upon a type of the associated decoded source command.

17. The method of claim 16, wherein the type of the associated decoded source command comprises one of a read operation and a write operation.

18. The method of claim 13, further comprising:
generating one or more scripts based upon the decoded source commands and test data; and
applying the scripts to an integrated circuit implementing the DUT.

19. A method for displaying decoded data associated with a communications link in a graphical user interface (GUI), the method comprising:
displaying a graphical user interface comprising a protocol description window, a protocol waveform window and a register abstraction layer (RAL) painter window;
generating, based upon commands and data sent on the communications link, one or more waveforms each associated with a signal of the communication interface, and displaying the one or more waveforms in the protocol waveform window;
generating one or more transaction windows, each transaction window associated with a command and associated data sent on the communications link;
configuring one or more visual attributes of each transaction window based upon one or more characteristics of the associated command and associated data sent on the communications link; and
displaying the associated command and associated data in the associated transaction window with the configured visual attributes.

20. The method of claim 19, further comprising setting a color of each transaction window based upon a type of the associated decoded source command, wherein the type of the associated decoded source command comprises one of a read operation and a write operation.
